(19) United States
(12) Patent Application Publication
(10) Pub. No.: US 2013/0307775 A1
(43) Pub. Date: Nov. 21, 2013

(54) GESTURE RECOGNITION

(71) Applicant: STMicroelectronics R&D Limited, Marlow (GB)

(72) Inventor: Jeffrey M. Raynor, Edinburgh (GB)

(73) Assignee: STMicroelectronics R&D Limited, Marlow (GB)

(21) Appl. No.: 13/894,690

(22) Filed: May 15, 2013

(30) Foreign Application Priority Data
May 15, 2012 (GB) 1208523.9

(51) Int. Cl. G06F 3/01; G06F 3/02

(52) U.S. Cl. CPC G06F 3/017; G06F 3/0202
USPC 345/158; 345/156; 345/168

(57) ABSTRACT

A system includes two or more optical sensors configured to generate image data based on gestures made by a user. One or more processing devices identifies movement quadrants based on the generated image data. If a match of the identified movement quadrants to one of a set of gesture commands is detected, one or more control signals associated with the matching gesture command are generated.

### BACKGROUND

1. Technical Field

The present disclosure relates to systems, devices and methods for gesture recognition, and in particular for receiving gesture input from a user.

2. Description of the Related Art

The use of positioning devices such as mice, tracker balls, and touch pads and so on to allow a user to control the position of a cursor or suchlike on a display screen has been known for many years. However, more recently gesture based control techniques have been developed that seek to go beyond simple cursor control by enabling devices to recognize particular “gestures” input by a user. Such gestures have certain control actions associated with them. For example, a “pinch” gesture may be used for zoom out, a “spread” gesture may be used for zoom in, and a “sweep” gesture may used to scroll and so on.

Gesture based control is used to allow users to interact with computing devices such as smart-phones, tablet computers, portable personal computers and so on.

For example, it is well-known to provide devices such as smart-phones and tablet computers with a touch sensitive surface overlaid on a display screen. The touch sensitive surface detects movement of one or more of a user's fingers over the surface, then the device associates this movement with one or more predefined gestures and generates corresponding control information which is used to control the device. For example, if a user, viewing an image on the display screen of such a device places two fingers on the screen overlaid with a touch sensitive surface and then moves their fingers apart, this movement is recognized as a pre-defined “zoom-in” gesture and the image on the display screen is magnified accordingly.

Similarly, most portable personal computers such as laptops, note-books, net-books and so on are provided with a touch sensitive pad, typically positioned below a keypad, which allows a user to control a cursor on a display screen. In some examples, such portable personal computers are also arranged to recognize gestures input by a user on the touch pad.

Enabling a computing device to recognize and respond to gesture based control is clearly advantageous because it provides a user with more control over the device. However, integrating conventional gesture recognition hardware into computing devices can be complicated and expensive. Fitting a touch sensitive surface to a device will increase the cost of the device and require additional hardware and software to convert the user's finger touches into meaningful gesture control. Whilst gesture based control enhances the way in which a user can control a device, it is nonetheless expensive and complicated to provide a computing device with hardware that is able to recognize gesture input.

### BRIEF SUMMARY

In an embodiment, a system comprises a user input device including a plurality of optical sensors, each of said optical sensors arranged to detect a velocity (e.g., speed and direction) of one of one or more user parts (such as one or more user fingers) relative to said optical sensor. The user input device is arranged to generate movement data corresponding to the detected velocity of the one or more user parts. The system further comprises a gesture processor arranged to receive the movement data, match the movement data with one or more pre-defined gestures and generate corresponding control information associated with the one or more predefined gestures.

Conventional gesture control techniques generate gesture control information by monitoring changes in position over time of user contact points (e.g., user parts such as user fingers) on a two dimensional surface (e.g., touch pad, touch sensitive screen etc) and from this attempt to recognize user gestures. The processing required to generate gesture control information using such techniques is complicated. The position of one or more different contact points must be accurately tracked in two-dimensional space and processing must be provided to reduce false positives (e.g., the detection of a gesture when the user has not performed the corresponding gesture). This is particularly difficult in “multi-touch” implementations where the user uses two or more contact points to input gestures.

Furthermore, touch sensitive surfaces such as capacitive touch screens and touch pads that are required to implement conventional gesture recognition techniques are expensive and consume a lot of device power during operation and are therefore unsuitable for many applications that would otherwise benefit from being enabled to receive gesture control input.

The inventor has realized that by providing a user input device with two or more optical sensors an improved gesture recognition system can be implemented which is lower cost and simpler to implement than gesture recognition using conventional techniques. Whereas conventional techniques rely on “position over time” monitoring, the inventor has realized that by providing a number of suitable optical sensors, velocity information relating to the velocity of a user part relative to the optical sensors can be captured from which gesture control information can be readily derived. As a result there is no need to monitor the actual position of the user parts over time in a two dimensional area, merely the velocity of the user parts relative to the optical sensors.

The reduction in complexity arising from capturing only velocity information means that much of the gesture recognition processing that would otherwise be performed on a central processor of a computing device can be performed on the user input device itself and even, if so desired, at the optical sensor. Moreover, the types of optical sensors necessary to detect the relative velocity of a user parts are less expensive than the corresponding position monitoring hardware (e.g., capacitive touch screens and touch pads and so on).

In some embodiments the movement data generated by the user input device corresponds to motion vectors representing a velocity of the one or more user parts relative to the optical sensors. By representing the movement data as a motion vector, accurate information regarding the velocity of the user parts relative to the optical sensors can be provided but in a format that is simple to transmit to other components of the system and easy to process. In some embodiments the movement data corresponds to a directional quadrant corresponding to which of a plurality of directional quadrants each motion vector falls within. A motion vector typically comprises a value representing magnitude (or a normalized unit magnitude) and a directional value. In accordance with these embodiments, the motion vector is simplified by representing the directional component as one of a plurality of directional quadrants. This reduces the amount of information used to represent the movement data but still retains enough information to allow meaningful gesture information to be derived. In some embodiments the directional quadrants comprise four directional quadrants corresponding to up, down, left and right. As a result the movement data can be represented by a further reduced amount of information for example two bits (e.g., 00=up, 01=down, 10=right, 11=left).

In some embodiments the movement data is generated for a motion vector when the motion vector has a magnitude greater than a threshold magnitude. Accordingly, in order to generate movement data, a threshold velocity is detected. This reduces the likelihood of small or very slow user movements being incorrectly interpreted as gestures (e.g., false positives) and may reduce the effect of noise in the system, particularly if low-cost optical sensors are used.

In some embodiments the gesture processor is incorporated within the user input device. In such implementations, the gesture recognition is performed on the user input device itself, reducing the amount of processing necessary at a computing device to which the user input device may be attached.

In some embodiments, the plurality of optical sensors are arranged to capture a succession of images of the user part and the velocity of the one or more user parts is detected by comparing differences between images of the succession of images. Such optical sensors are widely available due to their use in other technical fields such as movement detectors in mass-produced devices such as optical mice. Such optical sensors are generally much lower cost than conventionally used touch sensitive surfaces reducing further the cost of implementing a user input device in accordance with example embodiments In such embodiments the optical sensors comprise a photo-detector coupled to a movement processor, said movement processor arranged to receive signals from the photo-detector to generate the succession of images.

The reduced cost and complexity of user input devices arranged in accordance with example embodiments is such that gesture recognition functionality can be implemented in low cost peripheral devices. For example, in some embodiments the user input device is a keyboard. In some embodiments the one or more optical sensors are positioned substantially between keys of the keyboard. In other embodiments the one or more optical sensors are positioned such that they replace one or more keys of the keyboard.

In some embodiments the user input device comprises a further optical sensor for providing cursor control.

In some embodiments the system further comprises a computing device coupled to the user input device, said computing device arranged to control a graphical display unit in accordance with the control information. The user input device described above is suitable for providing user input data for generating gesture control information for any suitable application but is particularly suitable for controlling the graphical display of a display screen such as a computer device display unit, a television and so on.

In some embodiments the one or more user parts are one or more user fingers.

In an embodiment, there is provided a user input device including a plurality of optical sensors, each optical sensor arranged to detect a velocity of one of one or more user parts relative to said optical sensor. The user input device is arranged to generate movement data corresponding to the detected velocity of the one or more user parts, wherein said movement data is suitable for matching with one or more pre-defined gestures enabling corresponding control information associated with the one or more predefined gestures to be generated.

In an embodiment, there is provided a processor for enabling gesture recognition. The processor is arranged to detect a velocity of one or more user parts relative to one or more optical sensors based on data output from the optical sensors and to generate movement data corresponding to the detected velocity of the one or more user parts. The movement data is suitable for matching with one or more pre-defined gestures enabling corresponding control information associated with the one or more predefined gestures to be generated.

In an embodiment, there is provided a method of gesture recognition comprising the steps of: detecting a velocity of one or more user parts relative to a plurality of optical sensors of a user input device; generating movement data corresponding to the detected velocity of the one or more user parts; matching the movement data with one or more pre-defined gestures, and generating corresponding control information associated with the one or more predefined gestures.

In an embodiment, a system comprises: a first optical sensor configured to generate image data; a second optical sensor configured to generate image data; and one or more processing devices configured to generate one or more control signals by: determining a first movement quadrant based on image data generated by the first optical sensor; determining a second movement quadrant based on image data generated by the second optical sensor; determining whether the first movement quadrant and the second movement quadrant are associated with a gesture; and when it is determined the first movement quadrant and the second movement quadrant are associated with the gesture, generating one or more control signals associated with the gesture. In an embodiment, the determining the first movement quadrant comprises determining a motion vector representing a velocity of movement of a user part relative to the first optical sensor. In an embodiment, the first movement quadrant is a directional quadrant of the motion vector. In an embodiment, the directional quadrant is one of four directional quadrants corresponding to up, down, left and right. In an embodiment, the one or more processing devices are configured to: compare a magnitude of the motion vector to a threshold magnitude; and determine the first movement quadrant when the magnitude of the motion vector exceeds the threshold magnitude. In an embodiment, the first optical sensor, the second optical sensor and at least one of the one or more processing devices are incorporated within a user input device. In an embodiment, the first optical sensor is configured to capture a succession of images and the one or more processing devices are configured to compare images of the succession of images. In an embodiment, the first optical sensor comprises a photo-detector coupled to a movement processor configured to receive signals from the photo-detector and to generate the succession of images. In an embodiment, the first optical sensor and the second optical sensor are incorporated into a keyboard. In an embodiment, the first and second optical sensors are positioned substantially between keys of the keyboard. In an embodiment, the first and second optical sensors are positioned such that they replace one or more keys of the keyboard. In an embodiment, the system comprises a further optical sensor configured to provide cursor-control data. In an embodiment, the system comprises a computing device configured to control a graphical display unit based on the one or more generated control signals. In an embodiment, the user part is a user finger.

In an embodiment, a user input device comprises: a plurality of optical sensors configured to generate image data; and one or more processing devices configured to generate quadrant information based on the image data generated by the plurality of optical sensors, wherein the quadrant information is associated with one or more control gestures of a plurality of control gestures associated with the input device. In an embodiment, the plurality of optical sensors are configured to generate image data based on movement of one or more user fingers. In an embodiment, the one or more processing devices are configured to: generate movement vectors based on the generated image data; and generate the quadrant information based on the generated movement vectors. In an embodiment, the one or more processing devices are configured to: detect when the quadrant information matches one of the plurality of control gestures; and when a match is detected, generate control signals corresponding to the matching control gesture.

In an embodiment, a device comprises: an input configured to receive image data; and one or more processing devices configured to generate one or more control signals by: determining a first movement quadrant based on received image data; determining a second movement quadrant based received image data; determining whether the first movement quadrant and the second movement quadrant are associated with a gesture; and when it is determined the first movement quadrant and the second movement quadrant are associated with the gesture, generating one or more control signals associated with the gesture. In an embodiment, the one or more processing devices are configured to: generate movement vectors based on received image data; and determine the first and second movement quadrants based on the generated movement vectors. In an embodiment, the one or more control signals comprise display control signals.

In an embodiment, a method comprises: generating, using a plurality of optical sensors, image data based on user gestures; determining, using one or more processing devices, a first movement quadrant based on the generated image data; determining, using the one or more processing devices, a second movement quadrant based on the generated image data; determining, using the one or more processing devices, whether the first movement quadrant and the second movement quadrant are associated with a command gesture; and when it is determined the first movement quadrant and the second movement quadrant are associated with the command gesture, generating, using the one or more processing devices, one or more control signals associated with the command gesture. In an embodiment, determining the first movement quadrant comprises generating a motion vector representing movement of a user part relative to one of the plurality of optical sensors. In an embodiment, the first movement quadrant corresponds to a directional quadrant of the motion vector. In an embodiment, the directional quadrant is one of four directional quadrants corresponding to up, down, left and right. In an embodiment, the method comprises determining whether the motion vector has a magnitude greater than a threshold magnitude.

In an embodiment, a non-transitory computer-readable medium's contents configure one or more processing devices to perform a method, the method comprising: determining a first movement quadrant based on received image data; determining a second movement quadrant based on received image data; determining whether the first movement quadrant and the second movement quadrant are associated with a command gesture; and when it is determined the first movement quadrant and the second movement quadrant are associated with the command gesture, generating one or more control signals associated with the command gesture. In an embodiment, the method comprises: generating a first motion vector based on the received image data; and generating a second motion vector based on the received image data, wherein the first movement quadrant is determined based on the first motion vector and the second movement quadrant is based on the second motion vector. In an embodiment, the first motion vector is indicative of a movement of a first user-finger relative to a first image sensor and the second motion vector is indicative of a movement of a second user-finger relative to a second image sensor.

In an embodiment, a system comprises: a plurality of means for generating image data; means for converting generated image data into data indicative of movement quadrants; means for identifying matches of data indicative of movement quadrants to gestures; and means for generating control signals associated with gestures in response to identified matches. In an embodiment, the means for converting comprises an input/output processor of a user-input device. In an embodiment, the means for generating control signals comprises a gesture processor of a computing device coupled to the user-input device.

A system may comprise: a first optical sensor configured to generate image data; a second optical sensor configured to generate image data; and one or more processing devices configured to generate one or more control signals by: determining a first velocity based on image data generated by the first optical sensor; determining a second velocity based on image data generated by the second optical sensor; determining whether image data generated by the first optical sensor and image data generated by the second optical sensor are associated with a gesture based on the determined velocities; and when it is determined image data generated by the first optical sensor and image data generated by the second optical sensor are associated with the gesture, generating one or more control signals associated with the gesture. The one or more processing devices may be configured to: determine a motion vector based on the first velocity, the motion vector representing a velocity of movement of a user part relative to the first optical sensor. The one or more processing devices may be configured to: determine a directional quadrant of the motion vector. The directional quadrant may be one of four directional quadrants corresponding to up, down, left and right. The one or more processing devices may be configured to: compare a magnitude of the motion vector to a threshold magnitude; and determine a movement quadrant associated with the motion vector when the magnitude of the motion vector exceeds the threshold magnitude. The first optical sensor, the second optical sensor and at least one of the one or more processing devices may be incorporated within a user input device. The first optical sensor may be configured to capture a succession of images and the one or more processing devices are configured to compare images of the succession of images. The first optical sensor may comprise a photo-detector coupled to a movement processor configured to receive signals from the photo-detector and to generate the succession of images. The first optical sensor and the second optical sensor may be incorporated into a keyboard. The first and second optical sensors may be positioned substantially between respective keys of the keyboard. The first and second optical sensors may be positioned such that they replace one or more keys of the keyboard. The system may comprise a further optical sensor configured to provide cursor-control data. The system may comprise a computing device configured to control a graphical display unit based on the one or more generated control signals. The user part may be a user finger. The one or more processing devices may be configured to: determine a first motion vector based on the first velocity, the first motion vector representing a velocity of movement of a user part relative to the first optical sensor; determine a second motion vector based on the second velocity, the second motion vector representing a velocity of movement of a user part relative to the second optical sensor; compare a magnitude of the first motion vector to a first threshold magnitude; compare a magnitude of the second motion vector to a second threshold magnitude; when the magnitude of the first motion vector exceeds the first threshold magnitude, determine a first movement quadrant based on the first motion vector; when the magnitude of the second motion vector exceeds the second threshold magnitude, determine a second movement quadrant based on the second motion vector; and determine whether the first movement quadrant and the second movement quadrant are associated with the gesture. The first threshold magnitude may be equal to the second threshold magnitude.

A user input device may comprise: a plurality of optical sensors configured to generate velocity information based on image data; and one or more processing devices configured to generate movement information based on velocity information generated by the plurality of optical sensors, wherein the movement information is associated with one or more control gestures of a plurality of control gestures. The plurality of optical sensors may be configured to generate image data based on movement of one or more user fingers. The one or more processing devices may be configured to: generate movement vectors based on the generated image data; and generate quadrant information based on the generated movement vectors. The one or more processing devices may be configured to: detect when the quadrant information matches one of the plurality of control gestures; and when a match is detected, generate control signals corresponding to the matching control gesture.

A device may comprise: an input configured to receive image data; and one or more processing devices configured to generate one or more control signals by: determining a first velocity based on received image data; determining a second velocity based received image data; determining whether the first velocity and the second velocity are associated with a gesture; and when it is determined the first velocity and the second velocity are associated with the gesture, generating one or more control signals associated with the gesture. The one or more processing devices may be configured to: generate movement vectors based on received image data; determine first and second movement quadrants based on the generated movement vectors, wherein determining whether the first velocity and the second velocity are associated with the gesture comprises determining whether the first and second movement quadrants are associated with the gesture. The one or more control signals may comprise display control signals.

A method may comprise: generating, using a plurality of optical sensors, image data based on user gestures; determining, using one or more processing devices, a first velocity based on the generated image data; determining, using the one or more processing devices, a second velocity based on the generated image data; determining, using the one or more processing devices, whether the first velocity and the second velocity are associated with a command gesture; and when it is determined the first velocity and the second velocity are associated with the command gesture, generating, using the one or more processing devices, one or more control signals associated with the command gesture. The method may comprise determining the first movement quadrant by generating a motion vector based on the first velocity, the motion vector representing movement of a user part relative to one of the plurality of optical sensors. The first movement quadrant may correspond to a directional quadrant of the motion vector. The directional quadrant may be one of four directional quadrants corresponding to up, down, left and right. The method may comprise determining whether the motion vector has a magnitude greater than a threshold magnitude.

A non-transitory computer-readable medium's contents may configure one or more processing devices to perform a method, the method comprising: determining a first velocity based on received image data; determining a second velocity based on received image data; determining whether the first velocity and the second velocity are associated with a command gesture; and when it is determined the first velocity and the second velocity are associated with the command gesture, generating one or more control signals associated with the command gesture. The method may comprise: generating a first motion vector based on the first velocity; generating a second motion vector based on the second velocity; generating a first movement quadrant based on the first motion vector and a second movement quadrant based on the second motion vector, wherein determining whether the first velocity and the second velocity are associated with the command gesture comprises determining whether the first movement quadrant and the second movement quadrant are associated with the command gesture. The first motion vector may be indicative of a movement of a first user-finger relative to a first image sensor and the second motion vector may be indicative of a movement of a second user-finger relative to a second image sensor.

A system may comprise: a plurality of means for generating image data; means for converting generated image data into data indicative of velocities; means for identifying matches of data indicative of velocities to gestures; and means for generating control signals associated with gestures in response to identified matches. The means for converting may comprise an input/output processor of a user-input device. The means for generating control signals may comprise a gesture processor of a computing device coupled to the user-input device. The means for identifying matches may comprise means for determining movement quadrants based on data indicative of velocities.

### BRIEF DESCRIPTION OF THE SEVERAL VIEWS OF THE DRAWINGS

Embodiments of the present disclosure will now be described by way of example only with reference to the accompanying drawings where like parts are provided with corresponding reference numerals and in which:

FIG. 1 provides a schematic diagram of optical movement sensor;

FIG. 2 provides a schematic diagram of an embodiment of a system;

FIG. 3a provides a schematic diagram illustrating an example output of an optical sensor;

FIG. 3b provides a schematic diagram illustrating a motion vector corresponding to the output of the optical sensor shown in FIG. 3a;

FIG. 4a illustrates an implementation of a motion vector simplification function in accordance with an embodiment;

FIG. 4b illustrates an implementation of a motion vector threshold function in accordance with an embodiment;

FIG. 4c illustrates a combined implementation of the motion vector simplification function shown in FIG. 4a and the motion vector simplification function shown in FIG. 4b in accordance with an embodiment;

FIGS. 5a to 5c provide schematic diagrams of example implementations of a user input device in accordance with example embodiments, and

FIG. 6 provides a schematic diagram of a system arranged in accordance with an example embodiment.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations, such as, for example, image sensors, processors, memories, etc., are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” “according to an embodiment” or “in an embodiment” and similar phrases in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of embodiments.

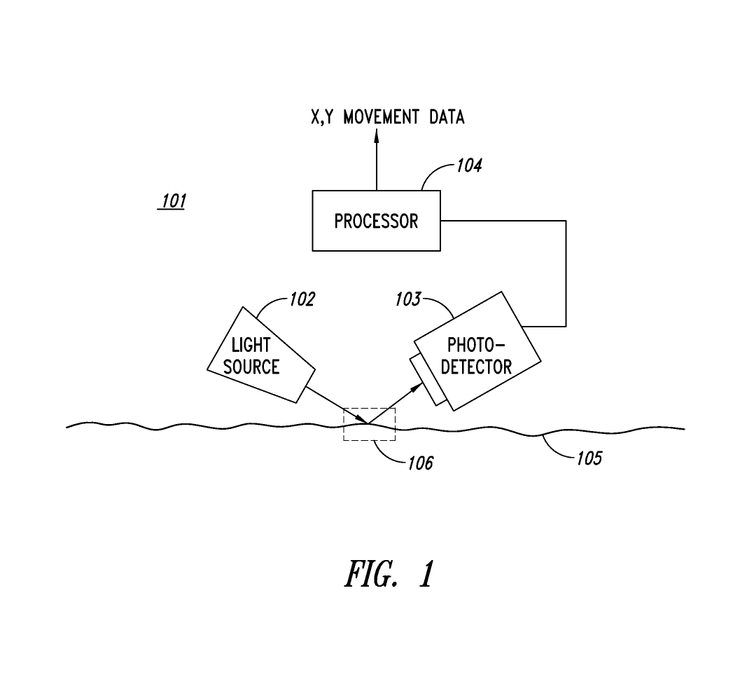

FIG. 1 provides a schematic drawing showing a conventional optical movement sensor 101. The optical movement sensor includes an illuminating light source 102 such as a light emitting diode (LED) 102 and a photo-detector 103 coupled to a movement processor 104. The optical movement sensor 101 is arranged to track movement of a surface 105 relative to the optical movement sensor 101. This is achieved by the photo-detector 103 capturing image data corresponding to an area 106 illuminated by the light source 102 under the optical movement sensor 101. As will be understood, although not shown in FIG. 1, typically the optical sensor also includes optical elements to direct the light from the light source 102 onto the area 106 being imaged and also optical elements to focus the light reflected from area 106 being imaged onto the photo-detector 103. The movement processor 106 receives the image data captured from the photo-detector 104 and successively generates a series of images of the area 106. These images are compared to determine the relative movement of the optical movement sensor 101 across the surface 105. Typically, the raw captured images are processed prior to comparison to enhance images features such as edges to emphasize differences between one image and another. Movement data corresponding to the relative movement determined by the movement processor 104 is then output, typically as a series of X and Y co-ordinate movement values. The X and Y co-ordinate movement values output from the processor 104 are sometimes referred to as “X counts” and “Y counts” as they correspond to the number of units of movement detected in the X plane and the number of units of movement detected in the Y plane during a given time period.

Typically, a “motion” signal is sent by the movement processor 104 when the motion sensor 101 has detected movement. The “motion” signal is sent to an external processor (not shown) to indicate that the optical movement sensor has detected movement. After receiving the “motion” signal the external processor then reads X count value and the Y count value from the movement processor 104 which corresponds to movement since the last motion data was read from the movement processor 104.

A well known application of optical movement sensors such as those of the type illustrated in FIG. 1 is to provide movement tracking in optical mice.

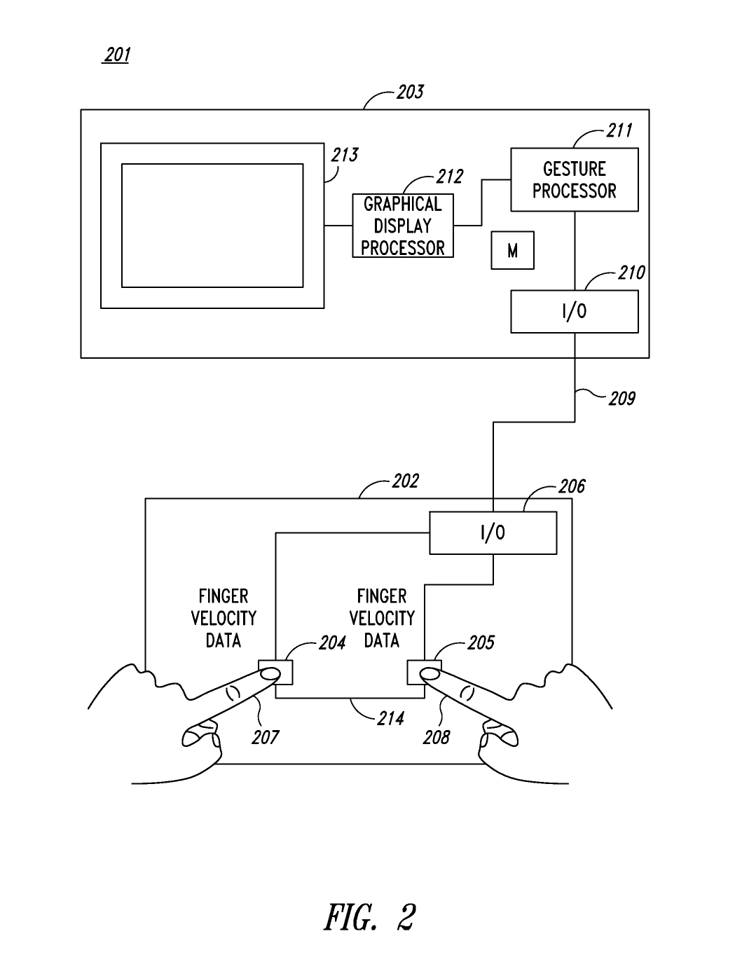

FIG. 2 provides a schematic diagram of an embodiment of a system 201. The system 201 is configured to detect a velocity of one or more objects of interest, such as user parts in the discussion herein, relative to optical sensors and convert this into control information based on gesture recognition. The user parts discussed below are described mainly in terms of user fingers, e.g., a digit on a user's hand such as a thumb, index finger, middle finger, ring finger or little finger on either the left or right hand. However, it will be understood that any suitable user part the velocity of which can be detected using optical sensors can be used such as a palm, wrist, forearm and so on. Similarly it will be understood that the terms “finger movement” “finger movement data” and “finger velocity data” used below can refer respectively to the movement, velocity and velocity data of any suitable object of interest (e.g., user part).

The system includes a user input device 202 and a computing device 203. The computing device may be any type of computing device such as a personal computer, games console, or equivalent device.

The user input device 202 includes a first optical sensor 204 and a second optical sensor 205. In some examples the first and second optical sensors 204, 205 correspond at least in part to the optical movement sensor 101 shown in FIG. 1 and include an illuminating light source, a photo-detector and a movement processor. However, it will be understood in other examples, any suitable optical sensor that can detect a velocity of a user part (such as a user's finger) relative to the sensor can be used.

The first and second sensors 204, 205 are typically connected via a data bus 214 to facilitate timing synchronization and so on. The user input device 202 also includes an input/output (I/O) interface unit 206 which is coupled to the first and second optical sensors 204, 205. The computing device 203 includes a graphical display unit 213 controlled by a graphical display processor 212.

In operation, each of the first and second optical sensors 204, 205 are arranged to detect the velocity of one of one or more user parts, such as a user fingers 207, 208, over the optical sensors 204, 205. The way in which user finger velocity is detected corresponds to the way in which the optical movement sensor shown in FIG. 1 determines movement of the surface 105 relative to the optical movement sensor 101. In other words for a given sensor a succession of images of a user finger is captured. These images are then compared to determine the relative movement of the finger with respect to the optical sensor over a given time period (typically the time period between read signals).

Each of the optical sensors 204, 205 is arranged to output finger movement data corresponding to the velocity of the user's fingers relative to the optical sensors. More detail relating to the finger movement data in an embodiment is provided below. The finger movement data is read from each of the optical sensors 204, 205 by the I/O interface unit 206.

In some examples the I/O interface unit 206 reads the finger movement data from the optical sensors at regular intervals. For example after a determined period of time has elapsed, the I/O interface unit 206 polls the optical sensors for the finger movement data. In this way, the I/O interface unit 206 receives finger movement data at a regular rate. However, in other examples, where for example power consumption is an important factor, if no finger movement is detected, each optical sensor remains in a sleep mode. If motion is detected, the optical sensor sends an interrupt signal to the I/O interface unit 206 and only then does the I/O interface unit 206 read finger movement data from the optical sensor.

After reading the finger movement data, the I/O interface unit 206 performs any further processing necessary to interpret the finger movement data, and then converts the finger movement data from the optical sensors 204, 205 into a format suitable for transmission between the user input device 202 and the computing device 203. The finger movement data is then transmitted from the user input device 202 via a connection 209 to the computing device 203.

The finger movement data output from the user input device 202 is received at the computing device 203 by an I/O interface unit 210, which converts it to a suitable format and then sends it to a gesture processor 211. In some examples the gesture processor is a central processing unit of the computing device programmed with a suitable driver and application. The computing device may comprise one or more memories M, which may be employed to store information, instructions, etc., for use, for example, by the gesture processor 211 and/or the graphical display processor 212.

The gesture processor 211 is arranged to correlate the finger movement data with one or more of a number of defined gestures, which may be pre-defined, and output a control signal corresponding to the defined gesture. The control signal is input to a graphical display processor 212 which converts the control signal into display control information which is used to control the output of the graphical display unit 213.

For example, a user may place two fingers 207, 208 on the user input device 202 (one finger over each optical sensor) and move the fingers 207, 208 towards each other. In other words, from the perspective of the system shown in FIG. 2, the first finger 207 moves to the right and the second finger 208 to the left. The velocity of the user's fingers is detected by the optical sensors 204, 205 as described above and corresponding finger movement data is generated by each optical sensor 204, 205 and sent to the user input device I/O interface unit 206. This finger movement data is processed and converted into a suitable transmission format and sent via the connection 209 to the computing device 203 and received at the computing device I/O interface unit 210. The received finger movement data is sent to the gesture processor. The gesture processor processes the finger movement data and interprets the finger movement data as a “pinch” gesture and determines that this is associated with a graphical “zoom out” command. The gesture processor 211 outputs a corresponding zoom out control signal to the graphical display processor 212 which performs a zoom out operation by, for example, shrinking the size of a graphical object displayed on the graphical display unit 213.

Finger Movement Data

As described above, the user input device 202 outputs finger movement data which is based on the velocity of the user's fingers as detected by the optical sensors. The finger movement data can be any suitable data which is indicative of the velocity of the user's fingers relative to the optical sensor. In some examples the finger movement data is in the form of motion vectors. This is explained in more detail below.

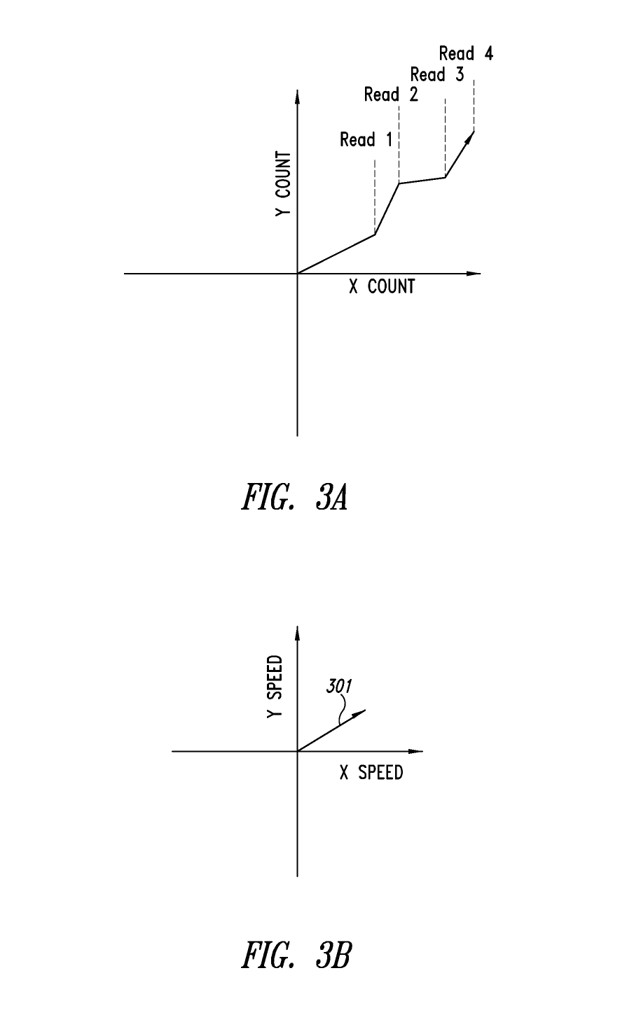

FIG. 3a provides a schematic diagram illustrating an example output of an optical sensor such as optical movement sensor 101 shown in FIG. 1.

At every occasion that the optical sensor is read from, the number of X counts and Y counts (e.g., units of movement detected in the X direction and units of movement detected in the Y direction) detected since the last time the optical sensor was read from are received by the external processor. An example plot of this information is shown in FIG. 3a. As can be understood from FIG. 3a, the X count and Y count information generated by the optical sensor corresponds to distance travelled in both the X and Y directions over a given period of time (e.g., since the optical sensor was last read from). The X count and the Y count data can be converted into a single “motion vector,” e.g., a vector the direction of which corresponds to the direction of the user's finger relative to the optical sensor, and the magnitude of which corresponds to the speed of the user's finger relative to the optical sensor.

As described above, in some embodiments, the optical sensors are regularly polled therefore the time period between X count and Y count reads is known from the frequency of this polling. In other examples, where for example an interrupt signal is sent when motion is detected by the optical sensor, other timing information can be used to determine the time between X count and Y count reads, for example by referring to a system clock. For example, a system clock time is recorded at the movement processor of the optical sensor and/or the I/O interface unit every time X count and Y count data is read from the optical sensor in response to an interrupt. To determine the time between X count and Y count reads, the system clock time recorded at the point of a previous read is subtracted from the system clock time of a current read.

FIG. 3b provides a schematic diagram illustrating a motion vector 301 derived from the X count and Y count information shown in FIG. 3a. As will be understood the magnitude and direction of the motion vector 301 can be updated every time new X count and Y count data is read from the optical sensor (either by virtue of regular polling of the optical sensors or by the generation of interrupt signals upon detection of movement).

In some examples the movement processor associated with each optical sensor 204, 205 is arranged to convert the X count and Y count data collected as described above into motion vector data which is then output to the I/O interface unit 206. In such examples the finger movement data read from each optical sensor corresponds to a stream of motion vectors, a new motion vector being generated every time the optical sensor is read from. In other examples, the optical sensors are arranged to output X and Y counts in a similar fashion to a conventional optical movement sensor and the I/O interface unit 206 is arranged to convert the X count and Y count data into motion vector data.

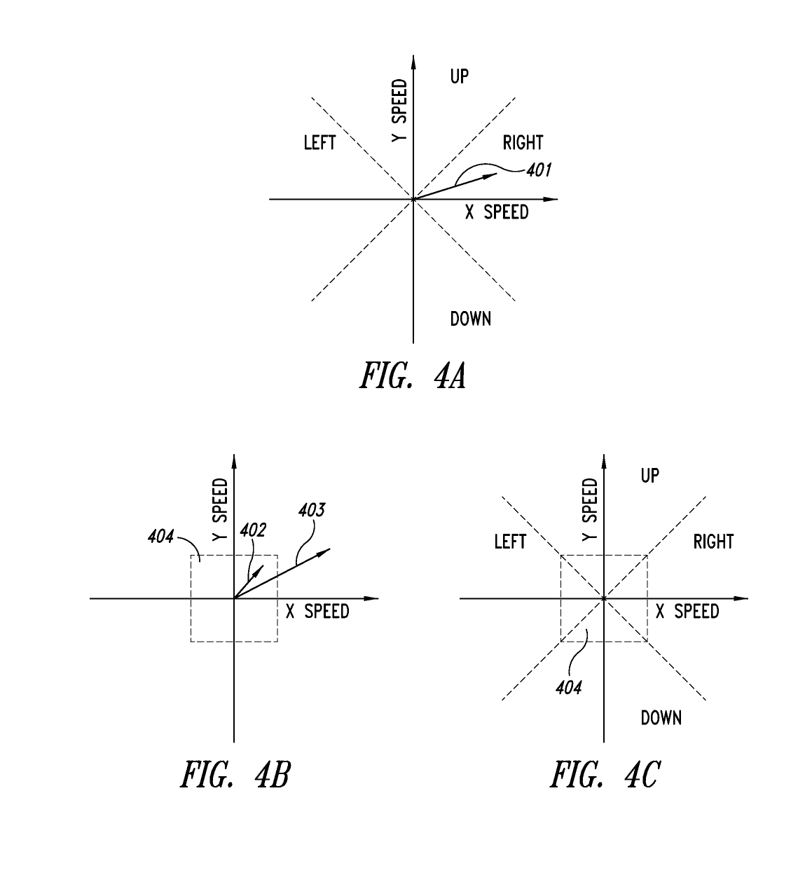

In some examples a motion vector simplification function is implemented. An example is shown in FIG. 4a. As will be understood, the motion vector simplification function can be implemented by the movement processor of the optical sensor or the I/O processing unit depending on which of the optical sensor and I/O processing unit converts the X count and Y count data to motion vector data.

FIG. 4a shows a plot of a motion vector 401 generated as described above from X count and Y count data. However, as can be seen from FIG. 4a, the plot is divided into four quadrants: UP, DOWN, LEFT and RIGHT. In one example, once the movement processor (or I/O processing unit) has generated a motion vector from the X count and Y count data as described above, rather than generating finger movement data corresponding to the precise motion vector (e.g., magnitude and direction), instead the movement processor (or I/O processing unit) outputs finger movement data in the form of simplified movement data corresponding to the quadrant within which the motion vector falls. For example, if the motion vector 401 falls within the RIGHT quadrant (indicating that the user's finger is moving to the right relative to the optical sensor), the optical sensor (or I/O processing unit) would output simplified movement data indicating that the user's finger is moving to the right. On the other hand, if the user's finger moves generally upwards relative to the optical sensor, the motion vector derived from the X count and Y count data would fall within the UP quadrant and the optical sensor (or I/O processing unit) would output simplified movement data indicating that the user's finger is moving to upwards and so on. As will be understood, the simplified motion vector in this case can be represented by two data bits or switches. For example, 00=up, 01=down, 10=right, 11=left. In this example, the magnitude of each motion vector is normalized to a unit magnitude.

In some examples a motion vector threshold function is implemented. An example embodiment is shown in FIG. 4b. As will be understood, the motion vector threshold function can be implemented by the movement processor of the optical sensor or the I/O processing unit.

FIG. 4b shows a plot showing a first motion vector 402 relating to finger velocity detected over a first period and a second motion vector 403 relating to velocity detected over a second period. In this example, the optical sensor (or I/O processing unit) will not output motion vector data unless the motion vector exceeds a threshold magnitude. The threshold magnitude is illustrated in FIG. 4b as an area 404 bounded by a broken line. As can be seen from FIG. 4b, the finger velocity detected by the optical sensor during the first period 402 results in a motion vector 402 that does not exceed the motion vector threshold. Accordingly, the optical sensor (or I/O processing unit) would not generate any finger movement data during the first period. On the other hand, the finger velocity detected by the optical sensor during the second period results in a motion vector 403 that exceeds the motion vector threshold. Accordingly, the optical sensor (or I/O processing unit) would output corresponding motion data during the first period.

In some examples, both the motion vector simplification function and the motion vector threshold function can be implemented at the same time. This concept is illustrated in FIG. 4c. In this example, a motion vector must exceed the motion vector magnitude threshold 404 for finger movement data to be generated by the optical sensor (or I/O processing unit). If a motion vector exceeds the motion vector magnitude threshold 404, simplified movement data corresponding to the quadrant within which the motion vector falls is output. Accordingly, user finger velocity corresponding to the first motion vector 402 does not result in any finger movement data being output but user finger velocity corresponding to the second motion vector 403 results in the optical sensor (or I/O processing unit) outputting simplified movement data indicating that the user's finger is moving to the right.

Tap Recognition

In some examples, along with detecting finger velocity, the optical sensors are configured to detect a “tap” by a user finger—e.g., detecting a user briefly putting their finger on, and then taking their finger off the optical sensor. The optical sensors may be arranged to detect this by recognizing the presence of the user finger for a determined duration consistent with a human finger “tapping” movement and with limited (e.g., below a threshold) finger movement during the determined duration. On detection of a tap, the optical sensor may be arranged to output a data indicating that a tap has been detected.

In other examples, a user tap is detected when a non-moving user finger is detected on a first optical sensor, whilst at the same time a user finger is detected on a second optical sensor that is moving.

Gesture Recognition performed on the User Input Device

In the example shown in FIG. 2, the gesture processor 211 is located externally of the user input device 202. However, in some examples the gesture processor is incorporated within the user input device. In such implementations, the gesture recognition is performed on the user input device itself and the output of the user input device corresponds to the detected gestures, e.g., gesture data corresponding to which of a number of determined gestures have been detected.

Single Processor on the User Input Device

In the example user input device shown in FIG. 2, the optical sensors (each including a movement processor) and the I/O processing unit 206 are shown as discrete units. However, it will be understood that this is for illustrative purposes only and any suitable arrangement of hardware can be used. In some examples the functionality associated with the optical sensors and the I/O processing unit 206 can be provided by a single device (e.g., integrated circuit) mounted within the user input device. This device may take as an input the images captured from the photo-detectors, and outputs finger movement data as described above or gesture data as described above.

User Input Device

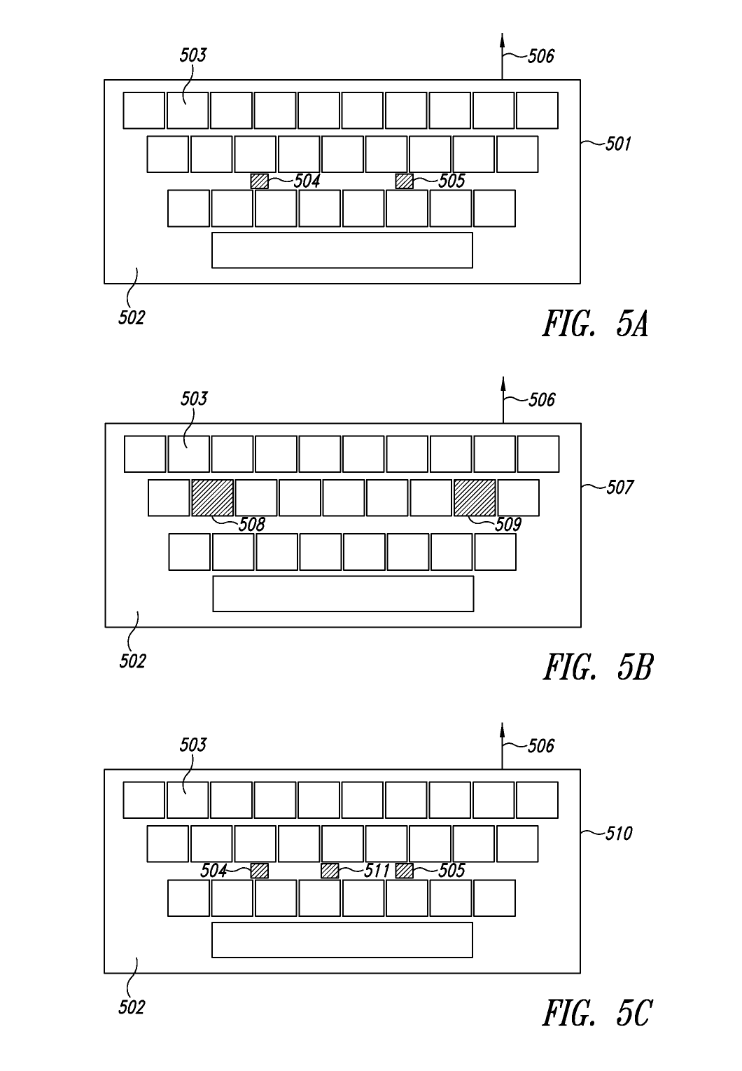

The user input device 202 shown in FIG. 2 can be arranged in any suitable fashion. In some examples, the user input device comprises a keyboard in which optical sensors have been integrated. Examples of this are shown in FIGS. 5a, 5b and 5c.

FIG. 5a provides a schematic diagram of a keyboard-based user input device 501 arranged in accordance with an example embodiment. The user input device 501 comprises a keyboard 502 comprising keys 503. However, unlike conventional keyboard based user input devices, the user input device 501 includes a first optical sensor 504 and a second optical sensor 505 which operate as described above with reference to the first and second optical sensors shown in FIG. 2. The first and second optical sensors 504, 505 are positioned between the keys 503 of the keyboard. As will be understood, the keyboard-based user input device 502 may typically include an I/O processing unit to receive the data output from the optical sensors 504, 505 and convert and output this data in a suitable format along with performing any of the other processing described above. The keyboard-based user input device 501 includes a data output connection 506 for transmitting user input data including finger movement data and, for example, key stroke data, to an external computing device such as a personal computer.

FIG. 5b provides a schematic diagram of a second keyboard-based user input device 507 arranged in accordance with another example embodiment. Like parts of the second keyboard based user input device 507 are numbered correspondingly with the keyboard based user input device shown in FIG. 5a.

In common with the keyboard-based user input device 501 shown in FIG. 5a, the keyboard based user input device 507 shown in FIG. 5b includes two optical sensors 508, 509. However, these optical sensors are positioned as if they were keys on the keyboard 502, in other words they are sized and/or positioned as if they were keys of the keyboard.

FIG. 5c provides a schematic diagram of a third keyboard-based user input device 510 arranged in accordance with another example embodiment. Like parts of the third keyboard based user input device 510 are numbered correspondingly with the keyboard based user input device shown in FIG. 5a. As can be seen from FIG. 5c, the keyboard-based user input device 510 corresponds with that shown in FIG. 5a except that the keyboard-based user input device 510 includes a third optical sensor 511. In some examples, rather than being arranged to detect user finger velocity from which gesture information is derived, the third optical sensor is arranged to detect finger movement from which cursor control data is derived.

### Example Implementation

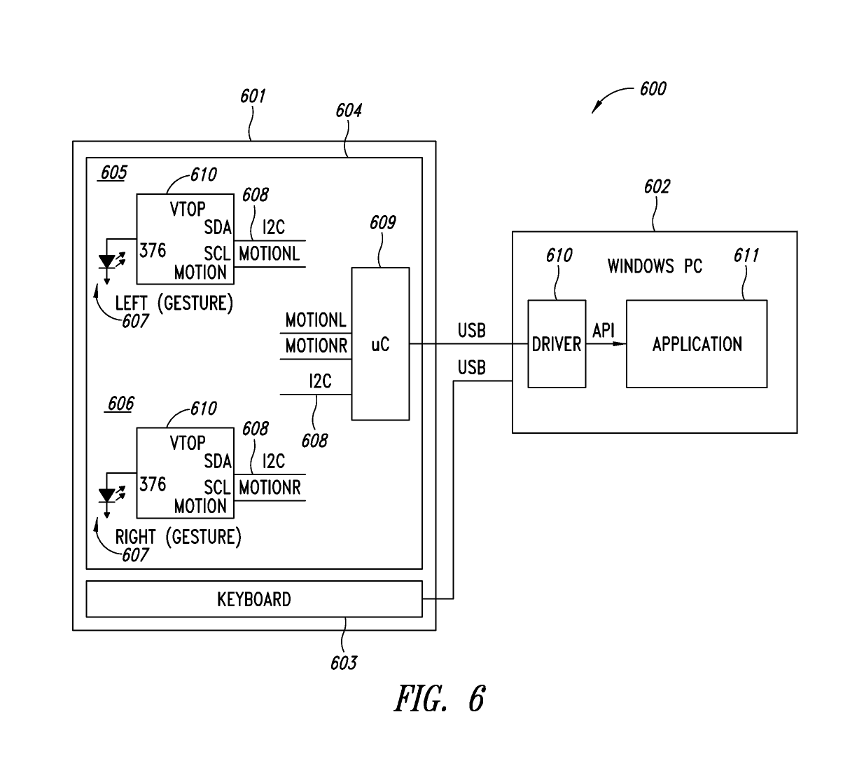

FIG. 6 provides a schematic diagram illustrating an implementation of a system 600 arranged in accordance with an example embodiment. The system includes a keyboard based user input device 601 connected via a universal serial bus (USB) interface to a personal computer (PC) computing device 602. As illustrated, the PC 602 employs the Windows® operating system. Other operating systems may be employed. The keyboard based user input device 601 includes a keyboard unit 603 and an optical sensor unit 604 including a first optical sensor 605 and a second optical sensor 606. Each optical sensor includes a photo-diode 607 and a sensor movement processor 610, which may be, for example, based on a STMicroelectronics VD5376 motion sensor device. It will be understood that other movement processors can be used, such as a STMicroelectronics VD5377 motion sensor device.

The first and second optical sensors 605, 606 are connected to a movement processor 609 via a MOTION line (MOTIONL for the first optical sensor 605 and MOTIONR for the second optical sensor 606) and a bus line, such as an I2C bus line 608.

If one of the optical sensor units detects movement, it sends an interrupt signal on the corresponding MOTION line to the movement processor 609. On receipt of the interrupt signal, the movement processor reads the X count and Y count data detected by the respective VD5376 motion sensor devices since it was last read. The first and second optical sensors may be configured to detect a user “tap” (e.g., finger present but not moving) by using the VD5376 registers (#features [0x31, 0x32], max exposed pixel [0x4F] and exposure [0x41]).

The microcontroller 609 outputs finger movement data via the USB interface to the PC 602. The PC 602 has installed thereon driver software 610 and application software 611 to correlate the finger movement data received from the keyboard based user input device 601 with one of a defined number of gestures and generate corresponding control information.

The microcontroller 609 may be configured to convert the X count and Y count data (corresponding to the velocity of a user's finger relative to the sensors) received from the first and second optical sensors 605, 606 into output switch data in accordance with a modified USB HID mouse class standard with ten switches as set out in the following table:

| Detected Motion | | Switch |
|---|---|---|
| First optical sensor: | Tap | 1 |
| First optical sensor: | Up | 2 |
| First optical sensor: | Down | 3 |
| First optical sensor: | Left | 4 |
| First optical sensor: | Right | 5 |
| First optical sensor: | No movement | No Switch of |
| | detected | switches 1 to 5 |
| Second optical sensor: | Tap | 6 |
| Second optical sensor: | Up | 7 |
| Second optical sensor: | Down | 8 |
| Second optical sensor: | Left | 9 |
| Second optical sensor: | Right | 10 |
| Second optical sensor: | No movement | No Switch of |
| | detected | switches 6 to 10 |

As mentioned above, the driver software 610 and the application software 611 installed on the PC are arranged to interpret the HID mouse class switch information with one of a defined number of gestures and generate/output corresponding control information. For an implementation in which the finger movement data output from the keyboard-based user input device is used to control the display of a graphical display unit, the mapping of the detected motion with corresponding gesture control may be achieved as set out in the following table:

| | | Second optical sensor switch | | | | |
|---|---|---|---|---|---|---|
| First optical | | 6 | 7 | 8 | 9 | 10 |
| sensor switch | | Tap | Up | Down | Left | Right |
| 1 | Tap | | Rotate CCW | Rotate CW | Flick Left | Flick Right |
| 2 | Up | Rotate CW | Scroll Up | | | |
| 3 | Down | Rotate CCW | | Scroll Down | | |
| 4 | Left | Flick Left | | | Scroll Left | Zoom Out |
| 5 | Right | Flick Right | | | Zoom In | Scroll Right |

It will be appreciated that the specific embodiments described above are described by way of example only and other embodiments and variations are envisaged.

For example, although the specific embodiments set out above have been described with reference to the optical sensors detecting velocity of a user finger, it will be understood that any suitable gesture input means the velocity of which can be detected by an optical sensor, can be used such as a stylus or pointer. Further, as described above, generally “finger” can be considered to refer to any appropriate part of the user such as any part of any digit on a user's hand, a user's palm, or wrist and so on.

Furthermore, it will be understood that the particular component parts of which the user input device and computing device are comprised, for example the movement processor, the I/O interface unit, the gesture processor and so are, in some examples, logical designations. Accordingly, the functionality that these component parts provide may be manifested in ways that do not conform precisely to the forms described above and shown in the drawings. For example aspects of one or more embodiments may be implemented in the form of a computer program product comprising instructions (e.g., a computer program) that may be implemented on a processor, stored on a data sub-carrier such as a floppy disk, optical disk, hard disk, PROM, RAM, flash memory or any combination of these or other storage media, or transmitted via data signals on a network such as an Ethernet, a wireless network, the Internet, or any combination of these of other networks, or realized in hardware as an ASIC (application specific integrated circuit) or an FPGA (field programmable gate array) or other configurable or bespoke circuit suitable to use in adapting the conventional equivalent device.

Some embodiments may take the form of computer program products. For example, according to one embodiment there is provided a computer readable medium comprising a computer program adapted to perform one or more of the methods described above. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the systems and/or modules may be implemented or provided in other manners, such as at least partially in firmware and/or hardware, including, but not limited to, one or more application-specific integrated circuits (ASICs), discrete circuitry, standard integrated circuits, controllers (e.g., by executing appropriate instructions, and including microcontrollers and/or embedded controllers), field-programmable gate arrays (FPGAs), state machines, complex programmable logic devices (CPLDs), etc., as well as devices that employ RFID technology. In some embodiments, some of the modules or controllers separately described herein may be combined, split into further modules and/or split and recombined in various manners.

The systems, modules and data structures may also be transmitted as generated data signals (e.g., as part of a carrier wave) on a variety of computer-readable transmission mediums, including wireless-based and wired/cable-based mediums. The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a first optical sensor configured to generate image data;
a second optical sensor configured to generate image data; and
one or more processing devices configured to generate one or more control signals by:
determining a first velocity based on image data generated by the first optical sensor;
determining a second velocity based on image data generated by the second optical sensor;
determining whether image data generated by the first optical sensor and image data generated by the second optical sensor are associated with a gesture based on the determined velocities; and
when it is determined image data generated by the first optical sensor and image data generated by the second optical sensor are associated with the gesture, generating one or more control signals associated with the gesture.

2. The system of claim 1 wherein the one or more processing devices are configured to:
determine a motion vector based on the first velocity, the motion vector representing a velocity of movement of a user part relative to the first optical sensor.

3. The system of claim 2, wherein the one or more processing devices are configured to:
determine a directional quadrant of the motion vector.

4. The system of claim 3 wherein the directional quadrant is one of four directional quadrants corresponding to up, down, left and right.

5. The system of claim 2 wherein the one or more processing devices are configured to:
compare a magnitude of the motion vector to a threshold magnitude; and
determine a movement quadrant associated with the motion vector when the magnitude of the motion vector exceeds the threshold magnitude.

6. The system of claim 1 wherein the first optical sensor, the second optical sensor and at least one of the one or more processing devices are incorporated within a user input device.

7. The system of claim 1, wherein the first optical sensor is configured to capture a succession of images and the one or more processing devices are configured to compare images of the succession of images.

8. The system of claim 7 wherein the first optical sensor comprises a photo-detector coupled to a movement processor configured to receive signals from the photo-detector and to generate the succession of images.

9. The system of claim 1 wherein the first optical sensor and the second optical sensor are incorporated into a keyboard.

10. The system of claim 9 wherein the first and second optical sensors are positioned substantially between respective keys of the keyboard.

11. The system of claim 9 wherein the first and second optical sensors are positioned such that they replace one or more keys of the keyboard.

12. The system according to claim 1, comprising a further optical sensor configured to provide cursor-control data.

13. The system according to claim 1, comprising a computing device configured to control a graphical display unit based on the one or more generated control signals.

14. The system according to claim 2 wherein the user part is a user finger.

15. The system of claim 1 wherein the one or more processing devices are configured to:
determine a first motion vector based on the first velocity, the first motion vector representing a velocity of movement of a user part relative to the first optical sensor;
determine a second motion vector based on the second velocity, the second motion vector representing a velocity of movement of a user part relative to the second optical sensor;
compare a magnitude of the first motion vector to a first threshold magnitude;
compare a magnitude of the second motion vector to a second threshold magnitude;
when the magnitude of the first motion vector exceeds the first threshold magnitude, determine a first movement quadrant based on the first motion vector;
when the magnitude of the second motion vector exceeds the second threshold magnitude, determine a second movement quadrant based on the second motion vector; and
determine whether the first movement quadrant and the second movement quadrant are associated with the gesture.

16. The system of claim 15 wherein the first threshold magnitude is equal to the second threshold magnitude.

17. A user input device comprising:
a plurality of optical sensors configured to generate velocity information based on image data; and
one or more processing devices configured to generate movement information based on velocity information generated by the plurality of optical sensors, wherein the movement information is associated with one or more control gestures of a plurality of control gestures.

18. The user input device of claim 17 wherein the plurality of optical sensors are configured to generate image data based on movement of one or more user fingers.

19. The user input device of claim 17 wherein the one or more processing devices are configured to:
generate movement vectors based on the generated image data; and
generate quadrant information based on the generated movement vectors.

20. The user input device of claim 19 wherein the one or more processing devices are configured to:
detect when the quadrant information matches one of the plurality of control gestures; and
when a match is detected, generate control signals corresponding to the matching control gesture.

21. A device, comprising:
an input configured to receive image data; and
one or more processing devices configured to generate one or more control signals by:
determining a first velocity based on received image data;
determining a second velocity based received image data;
determining whether the first velocity and the second velocity are associated with a gesture; and
when it is determined the first velocity and the second velocity are associated with the gesture, generating one or more control signals associated with the gesture.

22. The device of claim 21 wherein the one or more processing devices are configured to:
generate movement vectors based on received image data;
determine first and second movement quadrants based on the generated movement vectors, wherein determining whether the first velocity and the second velocity are associated with the gesture comprises determining whether the first and second movement quadrants are associated with the gesture.

23. The device of claim 21 wherein the one or more control signals comprise display control signals.

24. A method, comprising:
generating, using a plurality of optical sensors, image data based on user gestures;
determining, using one or more processing devices, a first velocity based on the generated image data;
determining, using the one or more processing devices, a second velocity based on the generated image data;
determining, using the one or more processing devices, whether the first velocity and the second velocity are associated with a command gesture; and
when it is determined the first velocity and the second velocity are associated with the command gesture, generating, using the one or more processing devices, one or more control signals associated with the command gesture.

25. The method of claim 24, comprising determining the first movement quadrant by generating a motion vector based on the first velocity, the motion vector representing movement of a user part relative to one of the plurality of optical sensors.

26. The method of claim 25 wherein the first movement quadrant corresponds to a directional quadrant of the motion vector.

27. The method of claim 26 wherein the directional quadrant is one of four directional quadrants corresponding to up, down, left and right.

28. The method of claim 25 comprising determining whether the motion vector has a magnitude greater than a threshold magnitude.

29. A non-transitory computer-readable medium whose contents configure one or more processing devices to perform a method, the method comprising:
determining a first velocity based on received image data;
determining a second velocity based on received image data;
determining whether the first velocity and the second velocity are associated with a command gesture; and
when it is determined the first velocity and the second velocity are associated with the command gesture, generating one or more control signals associated with the command gesture.

30. The non-transitory computer-readable medium of claim 27 wherein the method comprises:
generating a first motion vector based on the first velocity;
generating a second motion vector based on the second velocity; and
generating a first movement quadrant based on the first motion vector and a second movement quadrant based on the second motion vector, wherein determining whether the first velocity and the second velocity are associated with the command gesture comprises determining whether the first movement quadrant and the second movement quadrant are associated with the command gesture.

31. The non-transitory computer-readable medium of claim 30 wherein the first motion vector is indicative of a movement of a first user-finger relative to a first image sensor and the second motion vector is indicative of a movement of a second user-finger relative to a second image sensor.

32. A system, comprising:
a plurality of means for generating image data;
means for converting generated image data into data indicative of velocities;
means for identifying matches of data indicative of velocities to gestures; and
means for generating control signals associated with gestures in response to identified matches.

33. The system of claim 32 wherein the means for converting comprises an input/output processor of a user-input device.

34. The system of claim 33 wherein the means for generating control signals comprises a gesture processor of a computing device coupled to the user-input device.

35. The system of claim 32 wherein the means for identifying matches comprises means for determining movement quadrants based on data indicative of velocities.
